(19) United States
(12) Patent Application Publication
(10) Pub. No.: US 2012/0045691 A1
(43) Pub. Date: Feb. 23, 2012

(54) CARBON NANOTUBE BASED ELECTRODE MATERIALS FOR HIGH PERFORMANCE BATTERIES

(75) Inventor: Joel S. Douglas, Groton, CT (US)

(73) Assignee: MYSTIC TECHNOLOGY PARTNERS, Groton, CT (US)

(21) Appl. No.: 13/284,769

(22) Filed: Oct. 28, 2011

Related U.S. Application Data
(63) Continuation-in-part of application No. 12/485,099, filed on Jun. 16, 2009.
Application No. 12/485,099 is a continuation-in-part of application No. 11/897,077, filed on Aug. 29, 2007.
Application No. 11/897,077 is a continuation-in-part of application No. 11/579,750, filed on Aug. 10, 2007, now abandoned.
(60) Provisional application No. 61/537,703, filed on Sep. 22, 2011.
(60) Provisional application No. 61/537,752, filed on Sep. 22, 2011.
(60) Provisional application No. 61/132,688, filed on Jun. 20, 2008.
(60) Provisional application No. 60/856,967, filed on Nov. 6, 2006.
(60) Provisional application No. 60/851,946, filed on Oct. 16, 2006.
(60) Provisional application No. 60/576,195, filed on Jun. 2, 2004.

(51) Int. Cl. H01M 4/66; C23C 28/00; B05D 5/12; B82Y 30/00

(52) U.S. Cl. 429/211; 427/77; 427/78; 205/183; 205/184; 977/742; 977/773

(57) ABSTRACT

Improved battery materials, and a process for producing such improved battery materials are disclosed. The materials and methods employ battery components based on porous lightweight non woven substrate materials that are coated with dispersions comprised of carbon nanotubes, conductive secondary particles (usually with an approximate diameter between about 0.5 nm to 100 microns), a binder and a solvent. The dispersions permeate the substrate's pores, and when cured, the carbon nanotubes form conductive bridges between the conductive secondary particles, and these in turn are held on the substrate by the binder. The net effect is to increase the battery's total active material and energy density. The permeated substrate may then be further treated to achieve the desired conductivity as needed. These materials and methods can produce improved lead acid and silver zinc batteries, as well as other types of batteries.

### CROSS REFERENCE TO RELATED APPLICATIONS

This application claims the priority benefit of U.S. Provisional Application No. 61/537,703, filed on Sep. 22, 2011, entitled “Developing a Hybrid Battery Fuel Cell Power System;”, inventor Joel S. Douglas; and U.S. Provisional Application No. 61/537,752, filed on Sep. 22, 2011, entitled “Creation of a conductive matrix using oxidized base materials and carbon nanotubes”, inventor Joel S. Douglas, this application is a continuation in part of U.S. patent application Ser. No. 12/485,099, filed Jun. 16, 2009, entitled “Anode, Cathode, Grid and Current Collector Material for Reduced Weight Battery and Process for Production Thereof”, inventor Joel S. Douglas; application Ser. No. 12/485,099 in turn claimed the priority benefit of U.S. provisional application 61/132,688, filed Jun. 20, 2008, inventor Joel S. Douglas; this application is also a continuation in part of application Ser. No. 11/897,077, “Bondable Conductive Ink”, filed Aug. 29, 2007, inventor Joel S. Douglas; application Ser. No. 11/897,077 in turn claims the priority benefit of U.S. provisional applications 60/856,967 filed Nov. 6, 2006, and 60/851,946, filed Oct. 16, 2006; application Ser. No. 11/897,077 is also a continuation in part of application Ser. No. 11/579,750, entitled “Coatings Comprising Carbon Nanotubes”, inventor Joel S. Douglas, filed Aug. 10, 2007; Ser. No. 11/579,750 is a national stage entry of PCT application PCT/US05/19311, filed May 31, 2005, inventor Joel S. Douglas; PCT/US05/19311 in turn claims the priority benefit of provisional application 60/576,195, filed Jun. 2, 2004; inventor Joel S. Douglas; the disclosures of all of these patent applications are included herein by reference.

### FIELD OF THE INVENTION

The present invention relates to novel lightweight high performance battery materials, and methods to produce these novel lightweight high performance battery materials.

### BACKGROUND OF THE INVENTION

Advancements in technology have led to the production of handheld electronic equipment and other battery operated devices. These have revolutionized the consumer and industrial equipment industry. Batteries are now widely used in a variety of electronic devices, such as portable computers, portable tools, calculators, watches, cordless telephones, radios, tape recorders and security systems among others. Development of such electronic devices has brought about the evolution of batteries as miniature power supplies. These applications require that a new generation of batteries be developed that must produce higher energy per unit volume and superior discharge characteristics.

Batteries (e.g. battery electrochemical cells) are typically fabricated using an alkali metal anode, a non-aqueous electrolyte and cathodes of nonstoichiometric compounds, such as teachings of U.S. Pat. Nos. 4,621,035; 4,888,206; 4,911,995; 5,169,446 and U.S. Pat. No. 5,080,932. Of the alkali metals commercially feasible in manufacturing the anode material, lithium is preferred because it has a low atomic weight, while having a high electronegativity. These batteries require a high energy density, a long shelf life and efficient operation over a wide range of temperatures.

One known method for fabricating a battery cell is to use metal foils to form the current collectors for both the anode and cathode. The purpose of the current collectors is to provide a medium for transporting electrons to the terminals of the battery or cell. The use of copper and aluminum is expensive and results in additional battery weight. In production, the current collector can comprise a variety of conductive materials, including but not limited to stainless steel, copper, lead, nickel or aluminum. Subsequently, a cathode layer is positioned, preferably by extrusion or coating, so that it is in communication with the current collector. The next step is to form the anode, preferably by extrusion or coating, so that it is in communication with a second current collector. The separator and electrolyte layers are then positioned between the anode and cathode forming a current collector-cathode-electrolyte/separator-anode-current collector “sandwich.” The separator is used to prevent direct contact between an anode section and a cathode section. The separator can be a film or a fabric, depending on the battery type. In addition to maintaining physical separation of the anode section and the cathode section, a separator is designed to perform several other functions, such as forming an ionic pathway between the anode section and cathode section, electronic insulation, mechanical support and as a layer binding the anode section and cathode section. Normally the cell is then packaged in a metal enclosure, such that anode current collector is in electrical communication with the anode terminal exiting the enclosure and the cathode current collector is in electrical communication with the cathode terminal exiting the enclosure.

Previously, battery/cell manufacturing technology has relied on forming and assembling the current collectors, anode, electrolyte and cathode of the battery as separate components. This is a relatively labor intensive procedure that involves assembly of a number of discrete components, adding weight and cost to manufacture the battery (battery electrochemical cell). The current collector materials commonly used are lead, copper, aluminum, silver and zinc—expensive raw materials that add additional cost.

In response to these issues, there have been several developments in battery manufacturing processes. These advancements, described in U.S. Pat. No. 4,911,995 and U.S. Pat. No. 4,621,035, have relied on the use of a thin metal film as a metallization layer. This metallization layer is then employed with an alkali metal to form an anode. These approaches fail to provide a battery with the flexibility and durability required in some applications, and often the batteries are also complex to manufacture as well.

U.S. Pat. No. 6,025,089; U.S. Pat. No. 5,906,661; U.S. Pat. No. 6,045,942; U.S. Pat. No. 5,865,859; U.S. Pat. No. 5,735,912; and U.S. Pat. No. 5,747,191 describe the manufacture of thin film batteries including fusing an alkali metal onto a patterned conductive layer. Alternatively, thin film batteries can be manufactured using a method that includes providing a cathode base as a first nonconductive surface, adding a conductive layer to the first nonconductive surface formed from ink, then placing a cathode layer adjacent the conductive layer.

As electronic appliances have become smaller, lighter, and more capable, they have increasingly come to rely upon built-in high energy density rechargeable batteries. To satisfy this demand, the battery manufacturing and electronics community has shifted from lower performance rechargeable batteries (such as nickel-cadmium (Ni—Cd) have an energy density that can be 100-145 watt hour/liter) to higher performance rechargeable or secondary lithium ion batteries (which tend to have energy density in the 250-550 watt hour/liter range). However even such lithium-ion secondary batteries are still not enough to fully satisfy the demand for ever higher energy density or energy per weight rechargeable batteries. Thus further improvements in battery technology would be desirable.

### SUMMARY OF THE INVENTION

The invention is based, in part, on the insight that by producing improved battery components, such as improved non-metallic battery anodes, cathodes, grids, and current collector materials, batteries with various improved characteristics such as higher energy density can be produced. In particular, the invention is based in part on the insight that novel coatings and dispersions, in particular carbon nanotube based coatings and dispersions, may be particularly useful in this context.

In some embodiments, the invention also provides for the use of porous, non-metallic substrates, which allows the active cathode material to reside inside a conductive matrix. These embodiments are particularly useful for lower electrical conductivity materials such as LiFePO4, because these embodiments allow for considerably less binder and conductive diluent to be used, and also increase the amount of cathode material per volume of cathode. Additional advantages of the invention are that the flexible substrates of the invention retain good thermal properties, and are flexible enough to reduce the risk of hard shorting. Thus flexible substrates can lead to safer batteries, because hard shorting, caused by inflexible substrates, can lead to thermal runaway and resulting dangerous battery overheating. Thermal shorting and thermal runaway can also be caused by burr formation, which is often accidentally produced by during the substrate cutting and slitting process. An additional safety benefit of the invention's flexible substrates are that these substrates are also much less prone to bun formation during slitting and cutting, and thus are correspondingly safer in this way as well.

The present invention also relates to novel lightweight battery materials, enabling production of improved lightweight batteries having large capacity, high voltage and excellent charge-discharge cycle properties. Such improved batteries may additionally be free from decomposition of solvents of electrolytic solution. In some embodiments, the invention may be a process for production of an anode and cathode material for an improved battery, a process for production of the current collector material for an improved battery. In more specific embodiments, the invention may, for example, provide a process for production of an improved battery grid material for use in improved lead acid and silver zinc batteries.

More specifically, improved battery materials, and a process for producing such improved battery materials are disclosed. The materials and methods employ battery components based on porous lightweight non-woven substrate materials that are coated with dispersions comprised of carbon nanotubes, conductive secondary particles (usually with an approximate diameter between about 0.5 nm to 100 microns), a binder and a solvent. The dispersions permeate the substrate's pores, and when cured, the carbon nanotubes form conductive bridges between the conductive secondary particles, and these in turn are held on the substrate by the binder. The net effect is to increase the battery's total active material and energy density. The permeated substrate may then be further treated to achieve the final desired conductivity as needed. These materials and methods can produce improved lead acid and silver zinc batteries, as well as other types of batteries.

As a result, a ductile coating with very good adhesion to the substrate is produced. Because this coating can be infused into the high surface area of the non-woven fabric substrate, a high amount of active material can be imparted to the substrate, thus producing an improved lightweight battery with a higher corresponding energy density.

### BRIEF DESCRIPTION OF THE DRAWINGS

FIG. 1 shows the carbon nanotubes [20] affixed to the conductive powder material [10]. The connection site on the conductive powder material [15] is a defect created from the acid interaction.

FIG. 2 shows the island formation as of the larger conductive material and the nanotube linkages [20] to surface defect site [15] between particles [10].

FIG. 3 shows the nano channels [55] formed by carbon nanotubes [20] on the surface of the coating, ink, or dye [25].

FIG. 4A is an example of the anode (FIG. 4A) coating material [35] on non-woven substrates [30] for a lithium secondary battery of the present invention.

FIG. 4B is an example of cathode (FIG. 4B) coating material [40] on non-woven substrates [30] for a lithium secondary battery of the present invention.

FIG. 5A is an example of the anode (FIG. 5A) material on separate substrates for a li-ion cell, of the present invention. The catalyst or active material layer of the anode [50] is MCMB while the catalyst or active material layer of the cathode [45] is LiNiCoAlO2 in this embodiment.

FIG. 5B is an example of the cathode material on separate substrates for a li-ion cell, of the present invention. The catalyst or active material layer of the anode [50] is MCMB while the catalyst or active material layer of the cathode [45] is LiNiCoAlO2 in this embodiment.

FIG. 6 is a schematic view showing the material of the invention used in a lead acid battery as the grid. Two pieces of Melinex are cut to create grid [105] and tab [107]. This is die cut to create grid pattern [101] and grid [102]. This grid is spray coated with PbO2 [130] to create cathode [131]. A coating of Pb is applied [140] on both sides of the grid [102] forming the anode [141].

FIG. 7 is a schematic view showing the use of the material of the invention used in a silver zinc battery as the grid. Two pieces of Melinex are cut to create grid [105] and tab [107]. This is die cut to create grid pattern [101] and [102]. The grid pattern [101] is spray coated with a silver oxide dispersion [230] to the cathode [231]. A spray coating of zinc dispersion [240] is applied on both sides of the grid [102] forming the anode [241].

FIG. 8 is a graph showing a coating of the invention used in a battery undergoing a charging and discharging sequence.

FIG. 9 is a graph of weight of traditional materials versus the weight of materials of the invention.

FIG. 10 is a scanning electron microscope (SEM) image of the carbon nanotubes forming conductive ropes between larger traditional conductive particles.

### DETAILED DESCRIPTION OF THE INVENTION

Although organic materials and thick film inks, such as various polymers, have been used to create batteries in the past, such efforts have met with mixed results.

The invention is based, in part, on the insight that the processes that use polymer thick film inks have not been capable of providing a conductive layer from which to form an anode or cathode current collector capable of supporting high-energy applications. Many of the difficulties implementing polymer batteries are related to the temperatures created in the battery during discharge and recharging activities. The anodes and cathodes current collector formed from prior art polymers and inks cannot withstand the heat generated from recharging, rapid discharge, a long sustained discharge or multiple episodic discharges in a short period. These issues are compounded in part because the prior art polymer inks and films do not efficiently handle both heat and current.

The invention is also based, in part, on the insight that to achieve lighter weight batteries, there needs to be a change in the basic battery components, in particular by replacing traditional metals with new lightweight materials. To accomplish this, the coatings and films must be free from decomposition of solvents of electrolytic solutions used in the batteries, they must be capable of transferring both heat and current, they must be resistant to decomposition from the effects of the heat generated by charging and discharging and they must not interfere chemically with the electrochemical reaction.

The invention is also based, in part, on the insight that for many of these applications, battery electrodes formed in part from coatings formed from carbon nanotube containing dispersions may be particularly useful. In this context, the disclosures of U.S. Provisional Application No. 61/537,703, filed on Sep. 22, 2011, entitled “Developing a Hybrid Battery Fuel Cell Power System;”, U.S. Provisional Application No. 61/537,752, filed on Sep. 22, 2011, entitled “Creation of a conductive matrix using oxidized base materials and carbon nanotubes”, as well as U.S. patent application Ser. No. 12/485,099, and U.S. patent application Ser. No. 11/579,750 are useful, and these disclosures are incorporated herein by reference in their entireties.

Note that the carbon nanotube compositions may be often referred to as dispersions while they are in their wet state, and alternatively may be referred to as conductive coating once they have been applied to a substrate and often then subsequently cured. However it should be understood that the coatings are produced from dispersions, and conversely the dispersions will become coatings, and thus depending upon context, the two may occasionally be used interconvertably.

The present invention provides methods for improving the adhesion, ductility and electrical and thermal conductivity of a battery component coating made from dispersions of carbon nanotubes, conductive organic and inorganic materials, and metals. The invention is especially suited for use in batteries and other electrochemical applications where ductility, high bond strength, heat transfer, current transfer, improved manufacturability and resistance to burr formation when processing and chemical resistance to electrolytes and acids are necessary or desirable.

As will be discussed, over the course of the various experiments described herein, it has been found that for battery component purposes, carbon nanotube based coatings are advantageous because they form a conductive surface, have good adhesion to the chosen substrate, are easy to manufacture into sheets or rolls, eliminate the formation of burrs on the edges, have the ability to transfer heat, be ductile, and (after the coatings are applied to a substrate and then cured) are also chemically resistant to electrolytes and acids.

It has further been found that the materials and processes described herein can be used to inexpensively coat and infuse polymer substrates and other materials using a process that can be scaled up to industrial production size.

Note that although these materials and methods are well suited for producing improved battery components, in particular battery current collectors, anodes and cathodes with electrically conductive surfaces that are ductile, able to transfer heat, have high bond strength and are chemically resistant to electrolytes and acids; there are other applications for the concepts described herein as well. These other applications include fuel cells, photovoltaic cells, solar panels lower cost batteries, and electrochemical cells.

In one embodiment, the invention may be a current collector device for use in a battery. This current collector will generally comprising a substrate with at least one surface. This at least one surface will be coated with a mixture of carbon nanotubes and secondary conducting particles, so that at least some carbon nanotubes form electrically conductive bridges between at least some of these secondary conducting particles.

More specifically, in another embodiment, this current collector for a battery may comprise a non-woven, non-electrically conductive, fabric, fabric-like material, grid or veil substrate with an exterior surface and a porous internal matrix comprising interior surfaces. These exterior and interior surfaces are typically coated with a mixture of an organic polymer binder, carbon nanotubes and secondary conducting particles.

These secondary conducting particles comprise one or more particles, typically with an approximate diameter of between 0.5 nm to 100 microns, formed from materials such as carbon, Al, Cu Au—Ni, Au—Fe, Au—Co and Au—Ir, bi-metallics and their oxides, LiNiCoO2, LiNiCoAlO2, LiNiMnCoO2, coke, graphite, tin, mesocarbon microbeads (MCMB), silicon, non-metal oxides and metal oxides, Pb and PbO2, platinum, silver, zinc, silver oxide, zinc oxide, and other nanometals.

Usually these secondary conducting particles may comprise between 0.0001% to 60% of the coating by weight, the carbon nanotubes comprise from 0.1% to 10% of the coating by weight, and at least some of the carbon nanotubes form electrically conductive bridges between at least some of said secondary conducting particles.

Alternatively, in another embodiment, the invention may also be a method of creating a current collector for a battery (battery electrochemical cell). As will be discussed, this method will generally comprise creating a dispersion comprising a mixture of carbon nanotubes, conductive secondary particles, and a curable binder. More specifically the solids are formed by taking carbon nanotubes and first attaching them to the conductive secondary particles by utilizing introduced and natural defects in the conductive secondary particles as mounting points for the carbon nanotubes to attach to. This modified conductive solid matrix can then be formed into a dispersion. This dispersion will then be applied to a porous substrate (often a non-woven fabric, fabric like, or veil substrate) with a substrate exterior surface and a substrate interior matrix surface such that the dispersion is absorbed onto both the substrate exterior surface and substrate interior matrix surface of said substrate.

This substrate with the coated dispersion is then cured so that curable binder binds the mixture of carbon nanotubes and conductive secondary particles to the substrate exterior surface and substrate interior matrix surface. Here the materials and treatment methods will be selected so that at least some of the nanotubes form conductive links between at least some of said conductive secondary particles.

In general, the materials of the present disclosure may be applied to lightweight plastics, non-conductive materials, and other low-conductive plastic and polymer fabric materials. One benefit of this is that the resulting conductive members are significantly lighter in weight than currently used battery materials. Further the invention's novel materials may cost less, may be made into lower cost and potentially even safer batteries, which are easy to manufacture into sheets or rolls. The process can further eliminate the formation of burrs on the edges of such sheets and rolls.

The conductive coatings formed by using the carbon nanotube based dispersions described herein can also overcome various prior art problems, such as poor adhesion and lack of ductility, associated with prior art high solids concentration coatings. By contrast, carbon nanotubes based coatings, and coatings made from alloys of carbon nanotubes, have improved adhesion, increased repeatability of the conductive properties (both electrically and thermally), a low coefficient of friction, better ductility, improved heat transfer capabilities. Further, when the dispersions of carbon nanotubes are properly applied and cured, the invention's improved materials are also more chemically resistant to electrolytes and acids.

In general, for battery electrodes or other battery components, the more electrochemically active material that can be applied per unit battery component volume, the better. This process of increasing the amount of electrochemically active material per unit volume is often called “weight loading”.

Traditionally, increased weight loading has been achieved by increasing the chemical performance of the active materials; however this process can reach a limit if no better active materials can be found. Another problem is the flow of electrons in traditional battery materials, such as electrically conductive foils of copper and/or aluminum, causes both heat build-up and electrical conductivity restrictions. Further, because electrons are only able to flow on the outer surface of the materials traditionally used for battery current collectors, this results in wasted opportunity for electrical conductivity, a higher material cost, and lower battery cell performance.

Although in prior art, the core of the conductive matrix is not used to conduct electrons, in the case of the invention, the situation is quite different. Here the porous and often non-conductive substrates used in this invention, which typically have large internal surface areas, are infused with the conductive material that adheres to the large internal surface area of the porous substrate, the electrons are able to flow freely through the substrate using the outer diameters of the fiber. This approach thus significantly reduces heat build-up and improves electrical conductivity, because it provides an increase in surface area for the electrons to flow. Further the porous structure of the substrate material allows for the infusion of active material into the conductive matrix, which increases the weight loading of the volumetric area thereby, also increasing the battery cell performance (e.g. higher energy density). In particular, we have found that it is now possible to achieve increased weight loading (and thus higher battery energy capacity) by using porous substrate sheets, such as non-woven material or expanded sheet metal among others, and infusing the pores of these substrate materials with the active materials to achieve a higher energy density.

The porosity of the substrate may vary. Often the substrate will have porosity, defined by the ratio of the volume of the substrate's void-space divided by the total volume of the substrate, of around 0.5 or greater. Thus a preferred substrate, in addition to having a surface, will have a porous internal matrix or interior in fluid communication with the surface of the matrix. This internal matrix, which may be formed from the various fibers, membranes, sponge-like surfaces and voids, or other materials that form the substrate, acts to significantly increase the total surface area of the matrix that is in communication with the fluid or other electrolyte suspension normally used to create the battery.

Thus the term “coating” in this invention (e.g. any references to it within this document) refers to not only to coating the surface of the substrate, but also infusing the substrate's porous interior (e.g. interior pores, membranes and the like) with the particular carbon-nanotube based dispersion described herein. In alternate terminology, the coating process described herein can be viewed as also impregnating the substrate with the carbon-nanotube based dispersion as well.

The carbon-nanotubes in the dispersion, which help bind the dispersion's various conductive organic materials, inorganic materials, and metals into a carbon nanotube laced network, provide a number of useful properties, including a conductive surface and the ability to transfer heat. Such dispersions also tend to chemically resistant to electrolytes and acids as well. Without wishing to be bound by a theory, the inventor speculates that these useful properties are due in part by the dispersion's carbon nanotube component, and in part by the dispersion's other components. The non-carbon nanotube materials may be chosen for their chemical resistance. Further the carbon nanotubes provide single carbon atom deep layers which present a high surface area, form tight bonds between all of the materials, and are chemically resistant as well.

It is a general property of electrical transmission along a conductor that (electrons) travel along the surface of the conductor. Here, when the invention's carbon nanotube based dispersions are applied to, for example, a woven or non-woven fabric, the dispersions permeate the fabric and in particular coat the various fine strands of the fabric. This results in a substantial an increase in the substrate's surface area, which can be used for the transmission of electrons.

Thus in some embodiments, the invention provides for a substantial increase in conductive surface area because the summation of the surface area of the individual dispersion coated substrate strands is significantly greater than that of the surface area of a sheet of conductor of the same width. In most instances this increase is at least 150% greater. For example, a 1 inch square of non-woven material that averages 200 strands per inch by 0.005 inch strand diameter would have an available surface area of 3.14 inches or even substantially more. By contrast, the same size foil would have an available surface area of only 2 inches.

According to the invention, more than one type of carbon nanotube based dispersion or conductive coating may be used. In some embodiments, low solid dispersions of carbon nanotubes may be used. The conductive coatings made from cured dispersions of carbon nanotubes may be used to form a conductive material that can be alloyed with other conductive and non-conductive materials to achieve desired results.

The various conductive and non-conductive materials that may be used to create the inventions dispersions (and later conductive coatings) include carbon nanotubes, carbon nanotubes/antimony tin oxide, carbon nanotubes/platinum, carbon nanotubes and carbon, carbon nanotubes/silver or carbon nanotubes/silver-chloride, lead, amorphous carbon, carbon nanotubes and platinum, Au—Ni, Au—Fe, Au—Co and Au—Ir, bi-metallics and their oxides, LiNiCoO2, LiNiCoAlO2, LiNiMnCoO2, coke, graphite, silver oxide, zinc oxide tin, mesocarbon microbeads (MCMB), silicon, non-metal oxides and metal oxides, Pb and PbO2, platinum, Au—Ni, Au—Fe, Au—Co and Au—Ir, carbon, silver-chloride, silver, nickel, cadmium, and zinc.

Often the various dispersion materials may be in the form of small particles, often with diameters from 0.5 nm to 100 microns, as well as various nano metals such as nano size lead or nano oxide layers.

The dispersions and coatings of the invention are formed from conductive carbon nanotube dispersions may further include, as part of the formulation, carbon nanotubes, carbon nanotubes and platinum, amorphous carbon, carbon nanotubes/antimony tin oxide, silver, silver oxide, zinc, zinc oxide, lead, lead oxide or carbon nanotubes/silver, carbon nanotubes/silver-chloride, nano size metals, oxides, metal oxides and platinum.

Various types of nanotubes may be used to create the dispersions and coatings of the invention. These include single-wall nanotubes (SWNT), double-wall carbon nanotubes (DWNT) or multi-wall nanotubes (MWNT). In a preferred embodiment, the nanotube diameter is greater than 0.5 nm and less than 20 nm. This size range allows the carbon nanotubes to form bonds with the other dispersion particles, and help overcome the problems of oxidization when the materials are used in a matrix.

The invention's materials and methods may be used to create conductive matrices, such as inks or coatings, using lower cost non-nanotube particulate materials, such as copper and aluminum powders or flakes. Here the conductive properties of these non-nanotube particulate components may, prior to exposure to the nanotubes, be negatively affected by oxidation process. In other words the particles may often be surrounded by a non-conductive outer oxide layer. Here it is important to create holes or defect points in the non-conductive outer oxide layer, prior to exposure to nanotubes and prior to oxidation. If this is done, then the bonds between the carbon nanotubes and the other particulates in the dispersion may be formed at these defect points on the dispersion's non-nanotube powdered or flake components. Here use of an acid processing step can help increase the number of these defect points.

Here, the conductive and non-conductive materials that can be alloyed with the carbon nanotubes (CNT) can include antimony tin oxide, platinum, copper, aluminum, carbon, silver or silver-chloride, lead, amorphous carbon, ITO, platinum, Au—Ni, Au—Fe, Au—Co, Au—Ir, carbon silver-chloride, graphite, tin, silicon, indium, lead, MCMB, lithium-ion active materials, non-metal oxides and metal oxides powders or flakes.

Example of a dispersion prepared using copper powder and carbon nanotubes:

The particulate or flaked non-carbon nanotube conductive material (here metal powder particles often with a dimension of at least 100 nanometers) are used for the dispersion. According to the procedure [5 g-250 g] of this material may be prepared for use by placing it in a beaker filled with a 10 to 1 ratio of an acid [50 ml-2500 ml], in this case nitric acid (HNO3). Thus for 5 grams of copper powder, 50 ml of HNO3 would be used.

As previously discussed, this use of acid is advantageous because the acid creates defects on the surface of the conductive material. These defects, which can be viewed as being holes or gaps in the outer non-conductive oxide layer surrounding the particles, provide regions where the carbon nanotubes can then adhere to the surface of the conductive material (here copper particles). The process can utilize a variety of acids that are capable of etching the oxide from the powder or flake native material, including acetic acid, sulfuric acid, hydrogen chloride, hydrochloric acid, and tartaric acid. This list is not inclusive and many acids have the ability to remove the oxidation from the powder or flake.

The solution is then mixed with a hotplate stirrer and/or with sonication, for 5 to 20 minutes depending on the batch size and type of acid used. This acid step removes the oxidation layer from the powdered or flaked conductive materials. Once the oxidation layer has been removed, the conductive material powder or flakes is partially drained, and placed into another beaker filled with clean HNO3 at the same ratio. Here, the key to the partial draining is to keep the powder or flake material covered with acid so that it does not begin to oxidize.

To this new beaker, carbon nanotubes (CNT) are added. As previously discussed, these carbon nanotubes can include Multi Wall Carbon Nanotubes (MWNT), Double Wall Carbon Nanotubes (DWNT) or Single Wall Carbon Nanotubes (SWNT).

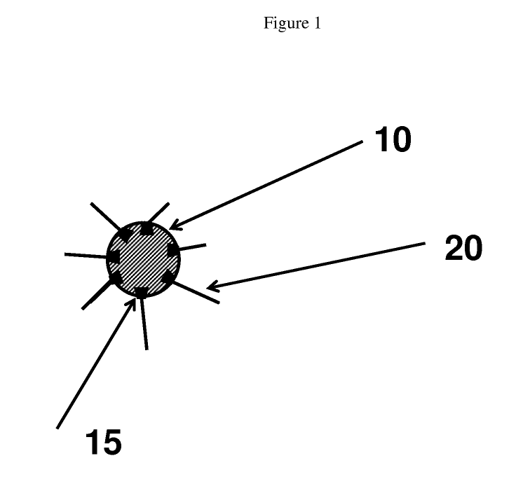

To affix the CNT to the conductive material particles or flakes, the entire beaker is sonicated or processed with a high shear mixer. This process affixes the carbon nanotubes [20] to the conductive material [10] at the connection site [15] that was created by the acid as seen in FIG. 1. The contents of the beaker can also be activated by microwave heating the mixture using a standard household microwave and heating the beaker (with 100 mls of liquid/powder) for 20 seconds on high power. The timing of the heating and the power requirements are dependent on the amount of liquid to be activated by the microwave heating. Then the acid is drained, and the carbon nanotube plus powder/flake material mixture is dried so that the acid is removed. This can be done with filter and air drying, vacuum drying, heated oven or other drying process.

In this example, the beaker is then drained and filtered with paper made from 50-100 g/cm² filter paper, leaving the conductive material affixed with carbon nanotubes. The resulting alloyed carbon-nanotube materials are thus composed of larger conductive particles (with a dimension of at least 100 nano meters along one axis) and carbon nanotubes affixed to said larger conductive particles. When formed into a dispersion and then coated on a surface, these carbon nanotube conductive material alloys end up with a particle distribution where, in contrast to prior art conductive particle dispersions, the invention's alloyed particles are spread substantially further apart from each other, and the particles are interconnected by the carbon nanotubes attached to the induced and natural defects in the larger conductive particles.

The various dispersions (e.g. inks, coatings and dyes) formed from this carbon-nanotube powder/flake matrix will often be held together by a binder, often a heat or ultra violet (UV) cured binder. These binders can be selected from a long list of polymers and organic materials customarily used in the ink, coating and dye process, and these are normally formulated with a corresponding solvent.

Although carbon nanotubes are naturally hydrophobic, as a result of the conductive particle—nanotube alloy process previously described. The resulting surface texture of the process creates particles with resulting hydrophilic behavior. However because the larger conductive particles are still relatively small, when formulated into an ink or coating, the carbon nanotubes interconnect the islands formed by these larger particles.

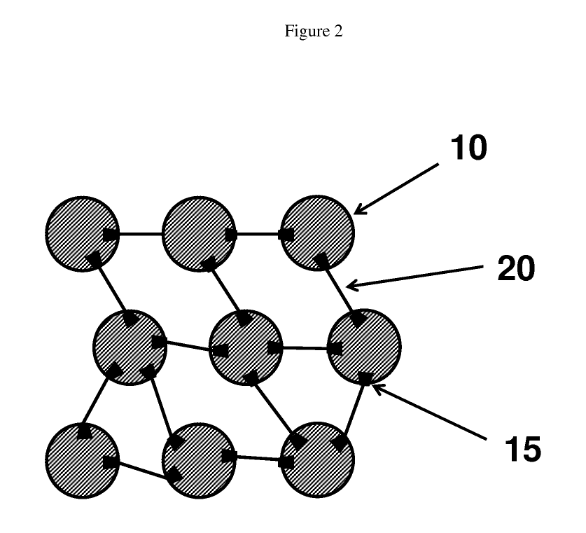

This island formation, as shown in FIG. 2, enables the larger conductive material [10] to be of a size that allows the nanotube linkages between particles [20]. As previously discussed, the use of acid creates defects on the surface of the material [15] allowing this linkage. This links the smaller conductive nanotube particles, which are capable of supporting high conductive loads and, and transfers these conductive loads to the conductive powder/flake through the un-oxidized attachment point on the powder/flake.

The linkages in this process are novel because they occur between the nanotubes, on one particle and the nanotubes on another particle. This occurs because during and after the curing process the traditional powder/flake material once again begins to oxidize. However since the nanotubes do not oxidize, they maintain their conductivity, and when placed in contact with another un-oxidized nanotube form a conductive path to the powder/flake particle. Further, the carbon nanotube attachment site on a powder/flake particle does not oxidize because it is in contact with the carbon nanotube, and forms the final path of electrical and thermal conductivity to the powder/flake particle.

Typically the final linkages between the carbon nanotubes occur after the application of the dispersion or ink to the surface of interest, and during the subsequent curing process that creates the final coating.

The curing process allows the carbon nanotubes to form bonds between themselves and other conductive materials in the dispersion after it is applied to a substrate. In batteries and other electrochemical applications, these coatings and infusions form conductive elements that can replace existing metal current collectors, grids and foils to transfer electrons to the cell or battery terminals, provide an excellent heat dissipation medium to the battery or cell wall where the heat is dissipated by transfer to the surrounding environment and do not interfere chemically with the electrochemical reaction.

The curing process can use heat over time to remove the solvents that make the wet dispersion, thereby creating a cured dispersion or cured dry ink, thus creating a coating. The dispersion that is created can also use solvents that react with UV light or other curing mechanism.

In some embodiments, there may be multiple dispersion coating steps and curing steps. For example, during a subsequent dispersion application and curing process, the carbon nanotubes in the subsequent dispersion may bond to the other nanotube bearing particles that are either part of that subsequent dispersion or which were applied earlier in a prior layer. Alternatively, the carbon nanotube attachments can form in the dispersion or coating matrix during a single application process.

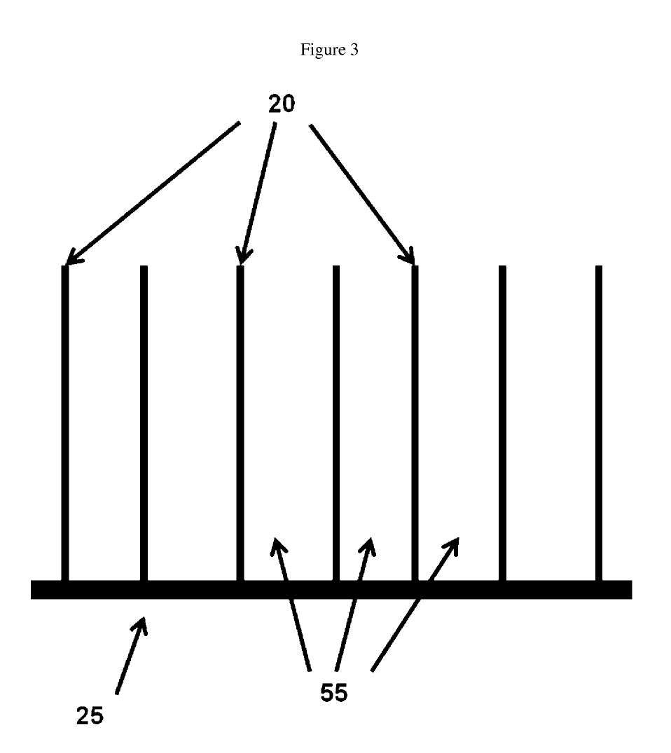

As previously discussed in parent application Ser. No. 11/897,077, the carbon nanotubes may also create a surface morphology that has carbon nanotubes protruding from the cured polymer portion of the cured dry ink. The unique surface is formed by the adhesion of carbon nanotubes [20] to the surface of the larger particles in the coating, ink, or dye [25] such that nano channels [55] are formed on the surface of the coating, ink, or dye as shown in FIG. 3. This creates hydrophilic capillaries for the liquid or attachment points/ultrasonic energy concentrator points useful for later ultrasonic welding operations or even soldering operations (which in turn may be used to weld the various components together to create a larger structure such as a battery).

The coatings and dispersions may be formed by combining the previously discussed carbon nanotube—conductive particle alloys with other conductive organics, inorganics, metals, oxides, metal oxides, carbon, carbon nanotubes and a suitable solvent. A preferred novel application of the invention uses the conductive material of the invention and mixes it with a solvent to form a uniform dispersion by sonication or other high shear mixing system. The resulting dispersion is mixed and applied to a substrate by spraying. The dispersion may also be applied by a method selected from the group consisting of: spray painting, dip coating, spin coating, knife coating, kiss coating, gravure coating, screen printing, stenciling and pad printing; and then heat cured for a specific amount of time which is optimally 20 minutes at 90 degrees C.

Such methods were described in U.S. Provisional Application No. 61/537,703, filed on Sep. 22, 2011, entitled “Developing a Hybrid Battery_Fuel Cell Power System;” as well as U.S. patent application Ser. No. 12/485/099, U.S. Provisional Application No. 61/537,752, filed on Sep. 22, 2011, entitled “Creation of a conductive matrix using oxidized base materials and carbon nanotubes”, U.S. patent application Ser. No. 11/579,750 filed on Feb. 21, 2008, the disclosures of which are incorporated herein by reference in their entireties.

An example of this formulation of the invention is as follows:

50 grams of copper powder, such as sigma Aldrich 207780, is suspended in 200 mls of nitric acid and sonicated with a Branson ultrasonic system until all the copper is suspended in dispersion. The copper is then allowed to settle to the bottom of the container. The nitric acid is then decanted so that only the copper powder and enough nitric acid remains to cover the copper. The next step involves adding 200 mls of nitric acid to the copper powder and then adding 2 grams of multi walled carbon nanotubes (MWCNT), in this case procured from Cheap Tubes of Brattleboro, Vt. The percentage of MWCNT's can be 0.1% to 10% of the copper by weight. The mixture is then mixed for 20 minutes with a Branson ultrasonic system until all the material is dispersed in the container. Then the dispersion is poured into a filter paper cone and allowed to dry. The drying can be accelerated with heat or vacuum.

Once the material is suitably dried so that there is no more liquid nitric acid present in the material and the material is returned to a dry powder, the material can then be added to 500 mls of acetone and then sonicated until a dispersion is formed. This dispersion can then be coated on polyester non-woven sheets, often a non-woven fabric, fabric like material, or veil, such as Hollingsworth & Vose 8000015—a carbon fiber and polyester binder non-woven carbon fiber surfacing veil, by spraying both sides to achieve an even coating of the copper/carbon nanotube dispersion on the non-woven substrate. The process is repeated for the other side. After both sides have been coated, the substrate material is cured. The dispersion may also be applied by a method selected from the group consisting of spray painting, dip coating, spin coating, knife coating, kiss coating, gravure coating, screen printing, stenciling and pad printing, then heat curing the application for a specific amount of time. The modified coating of the invention is applied and cured for 20 minutes at 90 degrees Celsius (C). As before, these methods were previously described in U.S. Provisional Application No. 61/537,703, filed on Sep. 22, 2011, entitled “Developing a Hybrid Battery_Fuel Cell Power System”, U.S. Provisional Application No. 61/537,752, filed on Sep. 22, 2011, entitled “Creation of a conductive matrix using oxidized base materials and carbon naotubes”, U.S. patent application Ser. No. 12/485,099, and U.S. patent application Ser. No. 11/579,750, the disclosures of which are incorporated herein by reference in their entireties.

Nearly any of the aforementioned coatings made from the dispersion of the invention can result in improved electrical conductivity with surface resistance in the range of less than approximately 1×10⁶ ohms/square per 1 mm square area. The coatings also have good adhesion to the substrate, excellent conductivity, both thermally and electrically, and are very chemically resistant after being applied to a non-conductive substrate and properly cured. The ability to use conductive materials that oxidize make the coatings significantly less costly than powders made from silver, which, subsequently are not useable in lithium-ion battery cell formation.

A preferred embodiment may include the following features:

The substrate will have a conductive carbon nanotube layer, here formed by coating/infusing the substrate with the carbon nanotube dispersion as previously described. Here these dispersions can be made from single walled nanotubes (SWNT) or multi walled nanotubes, preferably sized to have a diameter of less than 20 nm, and greater than 0.5 nm.

The conductive powders or particles used for this formulation may include powders such as Sigma Aldrich aluminum powder 653608, <1 μm particle size, 99.5% trace metals basis. These powders can be alloyed with either SWNT or MWNT and nanotube bundles or ropes, preferably sized to be greater than 0.5 nm and less than 20 nm in diameter. This choice of powder and nanotubes is done to achieve a coating that facilitates good adhesion, excellent conductivity, both thermally and electrically, and good ductility. When the aluminum powder is alloyed with either SWNT or MWNT, preferably sized to be greater than 0.5 nm and less than 20 nm in diameter, the conductivity of the resulting coating is approximately 5 ohms/sq. The carbon nanotube bundles, or ropes, that adhered to the aluminum particles during the dispersion process and the removal of the oxidation with nitric acid, provide the mechanism for this excellent conductivity. This is true even though the aluminum particulate material used in this example otherwise would rapidly form non-conductive oxide coatings. Thus in the absence of these nanotubes, this coating would not be conductive at all. The invention's dispersions/coatings can also be blended with various metals to form catalyst or active material layers as well. When these catalyst or active material layers are applied as part of the nanotube-particle top coating, less catalyst or active material is needed than would otherwise be the case when such catalysts are applied using prior art methods.

Such catalyst containing layers can contain carbon Au—Ni, Au—Fe, Au—Co and Au—Ir, bi-metallics and their oxides, LiNiCoO2, LiNiCoAlO2, LiNiMnCoO2, coke, graphite, tin, mesocarbon microbeads (MCMB), silicon, non-metal oxides and metal oxides, Pb and PbO2, platinum, carbon, silver-chloride, silver, silver oxide, zinc oxide, nickel, cadmium, and zinc. Typically these particles will have diameters from 0.5 nm to 100 microns or greater, or be nano metals such as nano size lead or various nano oxide layers that can be used in batteries or fuel cells. The metal particle or oxides particle size will often range in diameter from 0.5 nm to 40 nm. Such materials can be used in either primary or secondary batteries and fuel cells. The materials of the invention can be used as current collectors in batteries where their lightweight and high conductivity can replace the existing metal (e.g. copper, lead, aluminum) current collectors. When the oxides are mixed with various carbon nanotubes or lithium compounds, they can be used to replace the tradition lithium-ion materials. When used with lead acid batteries, the coating can be alloyed (or combined) with nano size lead to increase the lead content of the current collector/grid. When alloyed with a catalyst or active material such as platinum, silver oxide, zinc oxide, silver, zinc, lead and PbO2, platinum, Au—Ni, Au—Fe, Au—Co and Au—Ir, carbon, LiNiCoO2, LiNiCoAlO2, LiNiMnCoO2, coke, graphite, tin, mesocarbon microbeads (MCMB), silicon, non-metal oxides and/or metal oxides or nano oxide layers or nano metals such as nano size lead, they make excellent catalysts for use in electrochemical applications, Proton Electrolyte Membrane Fuel Cell (PEMFC) or in Solid Oxide Fuel Cells (SOFC). MCMB layer reactivity may be improved when alloyed with carbon nanotubes due to the increased carbon surface area provided by the carbon nanotubes. When these catalyst or active material layers are applied as part of the top coating, the amount of catalyst or active material required to achieve similar results is reduced when compared to uniform dispersion catalyst or active material coatings.

Alternatively a non-conductive binder can be used to form a dispersion used in the conductive coating or ink. The small size of the carbon nanotubes enhances adhesion of the coating to the base substrate for these conductive coatings because of their ability to bind to other materials. The powder formed from copper powder and carbon nanotubes can be blended with a non conductive binder, such a Kynarflex 2801-00, Elvanol, Zelec 1410M, Kynar, polyurethane, and Kynarflex using a percentage of 0.0001% to 60% by weight. Preferably, the carbon nanotubes are added such that they make up 4% by weight of the mixture. However, the weight of the carbon nanotubes can vary from 0.1% to 10% by weight. Then a solvent appropriate to the specific polymer substrate, such as chloroform, N-Methylpyrrolidone (NMP), Cylcopentanone, Dimethylsulfoxide (DMSO), Ethyl lactate, methyl ethyl ketone (MEK), Methyl Isobutyl Ketone (MIBK), Methanol, 1-methoxy-2-propyl-acetate, acetone or other suitable solvent for dissolving the polymer substrate, is added to the mixture to reduce the viscosity and form a liquid. The resulting dispersion is sonicated, or high shear mixed, and applied to the substrate. The carbon nanotubes and/or nano size metals knit together to form a conductive surface and infuse into the porous substrate when the dispersion is applied to a substrate and cured. The polymer binder provides porous mechanical protection for the conductive carbon nanotubes that permits the passage of electrons. The polymer binder is not conductive; the carbon nanotubes and metal nano particles are the only conductive pathway. The non-conductive polymer binder is used to coat the conductive particles that form the coating and protect it from wear and mechanical damage. The polymeric material is selected from the group consisting of thermoplastics, thermosetting polymers, elastomers, conducting polymers and combinations thereof. These polymeric materials can be selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, poly(methlmethacrylate), polynucleotides and mixtures thereof, or ceramic hybrid polymers, ethylene glycol monobutyl ether acetate, phosphine oxides and chalcogenides.

In another preferred embodiment, the coatings can be encapsulated with a top coating. For li-ion current collectors, the anode and or cathode material can either be top coated/plated with copper or be sputtered or vacuum deposited with aluminum to improve the handling of the current collector. When electrical plating is used the anode is placed in a copper plating bath until the copper has coated the spray coated non-woven material. The spray coating has made the non-woven material conductive enough to permit the plating process. Alternatively, the Li-ion Cathode can be sputtered or vacuum deposited with aluminum.

In another preferred embodiment, the invention provides a method for making multi-layer battery elements where the carrier, active materials and current collection material are all integrated into one element.

In another preferred embodiment, the invention provides a method for making a single layer battery element for use as a current collector or grid, where the carrier and current collector material are integrated into one element.

In another preferred embodiment, the invention provides a multi-layered structure comprised of electrically conductive inks and coatings formed from a dispersion, and a polymeric substrate layer disposed on at least a portion of said electrically conductive coatings.

In another preferred embodiment, the invention provides a multi-layered structure comprising electrically conductive coatings formed from dispersion and a polymeric substrate layer disposed on at least a portion of the electrically conductive inks and coatings in communication with a semi-conductive substrate.

In another preferred embodiment, the invention provides a multi-layered structure comprising electrically conductive coatings on polymeric substrates that are both easier to manufacture, and also eliminate the problems associated with burrs that can be formed on metal foils when cutting or slitting the foils found in traditional battery cells.

Other objects, features and advantages of the present invention will become apparent from the following detailed description. It should be understood, however, that the detailed description and specific examples, while indicating preferred embodiments of the invention, are given by way of illustration only, since various changes and modifications within the scope of the invention will become apparent to those skilled in the art from this detailed description.

### Experiments

At present, the current collector materials of currently available commercial batteries are often composed of lead, silver, stainless steel, zinc, copper or aluminum. These metals provide the following advantages: they are resistant to chemical degradation from electrolyte materials, they do not interfere chemically with the electrochemical reaction of the battery and they are capable of conducting electrons to the battery terminals. Materials of the present invention also provide these vital benefits, along with the added benefits of lighter weight, lower cost, ductility, elimination of metal components and the ability to form lightweight bipolar structures that are not envisioned in the prior art. These benefits can be used to achieve the following novel batteries:

1: Lighter weight batteries achieved by eliminating metal current collector components. This will allow the manufacture of lightweight batteries for military applications, aerospace, electric vehicles and consumer electronics.
2: Flexible, or ductile, battery components achieved by eliminating the metal current collector components. Metal current collector materials make battery components brittle and subject to cracking. This will allow the manufacture of flexible batteries for credit cards, aerospace and consumer electronics.
3: Increase the manufacturability and safety of the li-ion cell by eliminating the possibility of burrs, which can damage the polymer base separators used in li-ion cells.
4: Increased weight loading of active materials on the current collector which results in higher energy density for the cell.

### Experiments on the Thermal and Conductive Properties of Such Coatings

Here the electrical and thermal conductivity imparted by the invention's method to a coating is demonstrated. The data that is presented in this section was obtained using a polyester substrate, and a conductive coating that was formed from carbon nanotube dispersions as previously described. Similar results to those presented below have also been demonstrated using coatings of the invention, and non conductive materials.

### Summary of Results

A) Electrical resistivity, concentration and thickness of carbon nanotube filled conductive coatings: It was found that the resistivity of the coatings could be easily adjusted from 0.01 ohms squared to 100,000 ohms squared at any coating thickness greater than 1 micron.
B) Thermal conductivity is measured in watts per meter per Kelvin. Here good thermal conductivity is important in battery cell design, because it is needed to transfer the thermal energy generated when charging or discharging the cell.

Each of these parameters is presented in detail following a brief discussion on the testing plan.

The coatings used for testing were made for comparative properties testing between conductive coatings incorporating carbon nanotube dispersions applied in either a multi-step process, or as a single dispersion. In this matrix of samples, all preparation conditions, procedures and materials where identical for each of the conductive inks and coatings made. Each sample had an approximately uniform final conductive coating thickness of about 0.0001 inches applied to the non-woven substrate. The loading concentration of carbon nanotubes was determined from preliminary test conductive coatings created with carbon nanotube coatings with weight percentages between 0.03% and 3%. The coating thickness was selected to be 1 mil or less. The resulting sets of specimens were used in a test matrix comparing, A) electrical resistivity and B) thermal conductivity. The preparation and results of testing the samples in this matrix are presented as listed above.

### Example

### Preparation and Test Results for Samples

The first anode current collector samples were made with a non-conductive polymer, Kynarflex 2801-00, copper powder and carbon nanotubes. First, 50 grams of copper powder, such as sigma Aldrich 207780, is suspended in 200 mls of nitric acid, and used to create defects on the surface of the copper powder, thus generating nanotube connection sites as previously described. Here the copper powder is sonicated with a Branson ultrasonic system until all the copper is suspended in a dispersion. The copper is then allowed to settle to the bottom of the container. The nitric acid is decanted so that only the copper powder and enough nitric acid remains to cover the copper. The next step involves adding 200 mls of nitric acid to the copper powder and then adding 2 grams of MWCNT, in this case also procured from Cheap Tubes of Brattleboro, Vt. The percentage of MWCNT's can be 0.1% to 10% of the copper by weight. The mixture is then mixed for 20 minutes with a Branson ultrasonic system until all the material is dispersed in the container. Then the dispersion is poured into a filter paper cone and allowed to dry. The drying can be accelerated with heat or vacuum.

Once the material is suitably dried so that there is no more liquid nitric acid present in the material and the material is returned to a dry powder the material can then be added to 500 mls of acetone and then sonicated until a dispersion is formed.

Next take the dispersion and add 4 grams of Kynarflex 2801-00 binder powder and sonicate until completely dispersed, approximately 10 minutes. Prior to application, cut 8 by 10 inch sheets of Hollingsworth & Vose 8000015, a carbon and polyester binder non woven, and then spray coat the dispersion onto the substrate and cure for 1 min. at 95 degrees C. Repeat the application of the dispersion and curing step six additional times, forming a total of seven applications of dispersion. Then repeat for the opposite side. After both sides have been coated it is then cured. Cure the composite matrix by drying for 20 min. at 95 degrees C.; the permissible variation is 10 to 25 min. and 75 to 100 degrees C. The process allows the layers to be applied more thinly and the carbon nanotubes to form the conductive bonds. The carbon nanotube and conductive powder layers can be applied such that they create a layer with a thickness of less than 25 microns and the traditional conductive coating can be applied in a thickness between 25 microns and 0.01 inches.

The cathode current collector samples were made with a non conductive polymer, in this case Kynarflex 2801-00 binder powder, aluminum powder and carbon nanotubes. First 50 grams of aluminum powder, from sigma Aldrich 653608 powder, <1 μm particle size, 99.5% trace metals basis, is suspended in 200 mls of nitric acid and sonicated with a Branson ultrasonic system until all the aluminum is suspended in a dispersion. The aluminum is then allowed to settle to the bottom of the container. Next, the nitric acid is decanted so that only the aluminum powder and enough nitric acid remains to cover the aluminum. Next, 200 mls of nitric acid is added to the aluminum powder along with 2 grams of MWCNT, in this case procured from Cheap Tubes of Brattleboro, Vt. The percentage of MWCNT's can be from 0.1 to 10% of the aluminum by weight. The solution is then mixed for 20 minutes with a Branson ultrasonic system until all the material is dispersed in the container. The dispersion is then poured into a filter paper cone and allowed to dry. The drying can be accelerated with heat or vacuum.

Once the material is suitably dried so that there is no more liquid nitric acid present in the material and the material is returned to a dry powder, the material can then be added to 500 mls of acetone and then sonicated until a dispersion is formed.

Next take the dispersion and add 4 grams of Kynarflex 2801-00 binder powder and sonicate until completely dispersed, approximately 10 minutes. Prior to application, cut 8 by 10 inch sheets of Hollingsworth & Vose 8000015, a carbon and polyester binder non woven, and spray coat the dispersion onto the substrate and cure for 1 min. at 95 degrees C. Repeat the application of the dispersion and curing step six additional times, forming a total of seven applications of dispersion. The same steps are repeated for the opposite side. After both sides have been coated the substrate is cured. Cure the composite matrix by drying for 20 min. at 95 degrees C.; the permissible variation is 10 to 25 min. and 75 to 100 degrees C. The process allows the layers to be applied more thinly and the carbon nanotubes form the conductive bonds. The carbon nanotube and conductive powder layers can be applied such that they create a layer with a thickness of less than 25 microns and the traditional conductive coating can be applied in a thickness between 25 microns and 0.01 inches.

The following test results were obtained for various formulations: electrical, thermal and adhesion.

### Resistivity in Comparative Coatings.

A three-dimensional network of filler particles allows the conductive path to be imparted throughout a structure. This is referred to as percolation threshold, and is characterized by a large change in electrical resistance. Essentially, the theory is based on the agglomeration of particles, and particle-to-particle interactions, resulting in a transition from isolated domains to those forming a continuous pathway through the material. Nanotubes or nanoropes have a much lower percolation threshold than typical fillers due to their high aspect ratio, greater than 1000, and high conductivity. As an example, the calculated percolation threshold for carbon black is 3% to 4%, while typical carbon nanotubes have a threshold below 0.04%, or two orders of magnitude lower. This threshold value is one of the lowest ever calculated and confirmed (see J. Sandler, M. S. P. Shaffer, T. Prasse, W. Bauhofer, A. H. Windle and K. Schulte, “Development of a dispersion process for catalytically grown carbon nanotubes in a epoxy matrix and the resulting electrical properties”, University of Cambridge, United Kingdom, and the Technical University Hamburg, Hamburg, Germany).

The high conductivity imparted when nanotubes are dispersed in a coating at low concentrations (0.05-wt. % to 20-wt. %) is not typically observed in a conductive coating of the current art. This is one of the most useful aspects of using carbon nanotubes to make conductive coatings. A more common example is found in conductive coatings used in the electronics industry where polymers and other carriers are filled with carbon black to a loading of 10% to 30% by weight.

The high conductivity at low concentrations for coatings made from carbon nanotubes is due to the extraordinarily high aspect ratio of carbon nanotubes and high nanotube conductivity. In fact, the electrical and thermal conductivity of individual nanotubes has been measured and determined to exhibit metallic behavior. The curing, formulation and processing of the invention enhances the formation of ropes into a mat when the carbon nanotubes are applied and cured properly. This curing process improves the conductivity when using lower percentages (such as 0.5% by weight) of carbon nanotubes.

### Electrical Conductivity

To demonstrate electrical conductivity, the samples of the conductive mixture were coated onto non woven substrate. The results are shown in Table 1.

### Thermal Conductivity

To demonstrate thermal conductivity, the samples of the conductive mixture were coated onto non woven substrate. The results are shown in Table 1

### Summary of Test Results

Coatings of the invention have electrical conductivity much higher than required for current collector applications and can be easily designed for any level of electrical resistance, measured in Ohms/sq, above a 0.01 Ohms/sq. using very low loading level of nanotubes. Thermal conductivity is also high for a thin coating and is measured in watts per meter degree Kelvin. The carbon nanotube materials were more resistant to scratching, indicating better adhesion to the polyester substrate than the commercial coating.

TABLE 1
Coatings cured for 20 min. at 95 degrees C.

| | | Watts/ |
|---|---|---|
| Process | Ohms/Sq. | meter kelvin |
| Two layer conductive coating | 1100 | 80 |
| Three layer conductive coating | 120 | 100 |
| Five layer conductive coating | 3 | 120 |
| Seven layer conductive coating | 0.01 | 180 |

The coatings of the invention were then made and incorporated into battery cells.

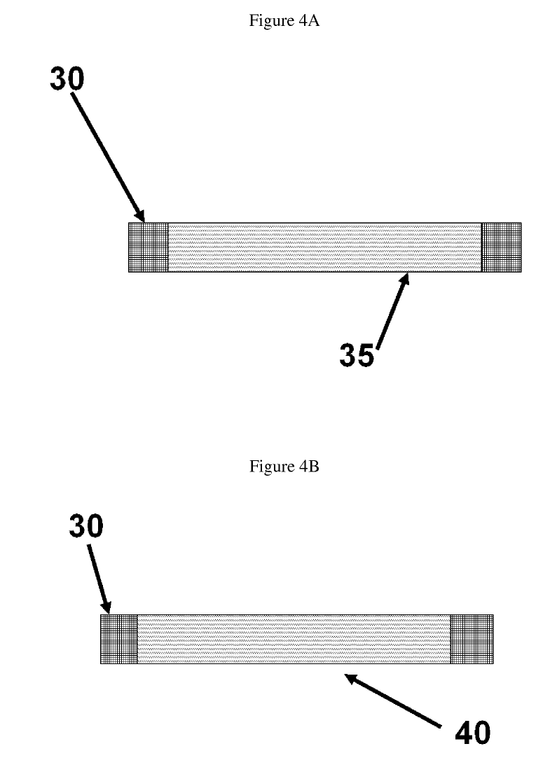

Using FIGS. 4A and 4B as a reference, the example of the anode material for a lithium secondary battery of the present invention is described. In this embodiment, the binder material is Kynarflex 2801-00. The copper anode dispersion formed as defined above to form coating [35] is sprayed using a stencil onto the non-woven substrate and cured, forming the conductive coatings for the current collector [30]. The dispersion is applied and dried seven times to form multiple layers and form the anode current collector as shown in FIG. 4A. The coating coats all the strands of the non-woven so that all the fibers have coating deposited on them. Using FIG. 4B as a reference; the example of the cathode material for a lithium secondary battery of the present invention is described. In this embodiment, the binder material Kynarflex 2801-00 is used. The aluminum cathode dispersion formed as defined above is sprayed using a stencil onto the non-woven substrate [30] and cured using heat at 95 C for 20 minutes, forming the conductive coatings [40] for the current. The dispersion is applied and dried seven times to form multiple layers and form the anode current collector material collector as shown in FIG. 4B. The coating coats all the strands of the non-woven so that all the fibers have coating deposited on them.

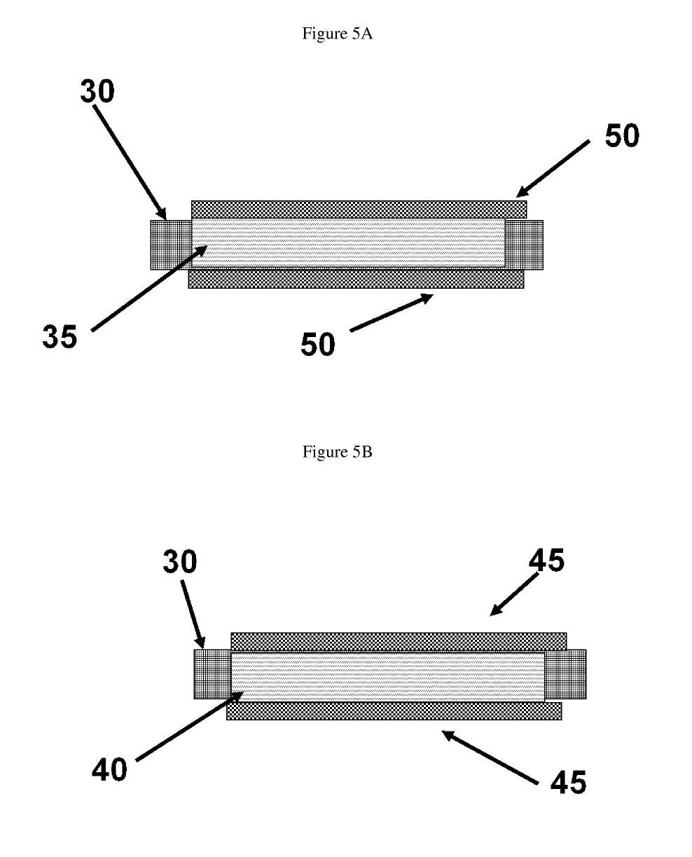

Using FIGS. 5A and 5B, an example of the anode and cathode material on separate substrates for a lithium ion cell, of the present invention is described. LiNiCoAlO2 [45] is coated onto one piece of the cathode current collector material to form the cathode and MCMB [50] is coated on one piece of the anode current collector material to form the anode, as shown in FIG. 5A. The corresponding cathode is shown in FIG. 5B. A standard CR2430 size coin cell battery was formed using these current collectors and the voltage, measured across the terminal, was 3.4 volts. Liquid electrolyte consisting of solid lithium-salt LiPF6 and ether was added to form the battery. The system could equally be formed with a gel polymer electrolyte.

The dispersions are formed by the following methods:

First, the MCMB powder is milled in a ball mill for 1 hour.

Next, LiNiCoAlO2 powder is milled in a ball mill for 1 hour.

Form a dispersion of LiNiCoAlO2 from 0.35 grams of LiNiCoAlO2 that has been ball milled into fine powder and added to 20 ml of acetone. Mix by placing the dispersion in a VWR 50 HT ultrasonic cleaner, for 10 minutes.

Form the MCMB dispersion by adding 0.35 grams of MCMB that has been ball milled into fine powder to 20 ml of acetone. Mix by placing the dispersion in a VWR 50 HT ultrasonic cleaner, for 10 minutes.

An airbrush spraying device, such as the Single Action Airbrush #1401 from Air Brush City, Nampa, Ind., USA, can be used to coat the anode and cathode material with the dispersion.

To form the cathode and anodes shown in FIGS. 5A and 5B, after the non woven coated cathode substrate has been cured, using a stencil, apply 5 ml of the LiNiCoAlO2 dispersion by spray coating to form layer [45] (as seen in FIG. 5B) to substrate. Cure by drying for 20 min. at 95 degrees C.; the permissible variation is 10 min. to 25 min. and 75 degrees C. to 100 degrees C.

After the non-woven anode substrate has been cured, cut the substrate into a piece that will form the cell. Using a stencil, apply 5 ml MCMB dispersion by spray coating to form layer [50] as seen in (FIG. 5A) of the substrate. Cure by drying for 20 min. at 95 degrees C.; the permissible variation is 10 min. to 25 min. and 75 degrees C. to 100 degrees C. Such steps were disclosed in U.S. Provisional Application No. 61/537,703, filed on Sep. 22, 2011, entitled “Developing a Hybrid Battery_Fuel Cell Power System;”, as well as U.S. patent application Ser. No. 12/485/099, and U.S. patent application Ser. No. 11/579, the disclosures of which are incorporated herein by reference in their entireties.

The battery is formed by creating a coin cell using the anode and cathode made from the composite materials. The voltage when measured across the terminals was 3.5 volts. The benefits of the composite structure are the elimination of the traditional metal foils and integration of the anode and cathode material into the carbon based current collector material. Any of the following materials could be substituted for the cathode: LiNiCoO2, LiNiCoAlO2, LiNiMnCoO2 and coke. Any of the following materials could be substituted for the anode: graphite, tin, mesocarbon microbeads (MCMB), silicon, non-metal oxides and metal oxide.

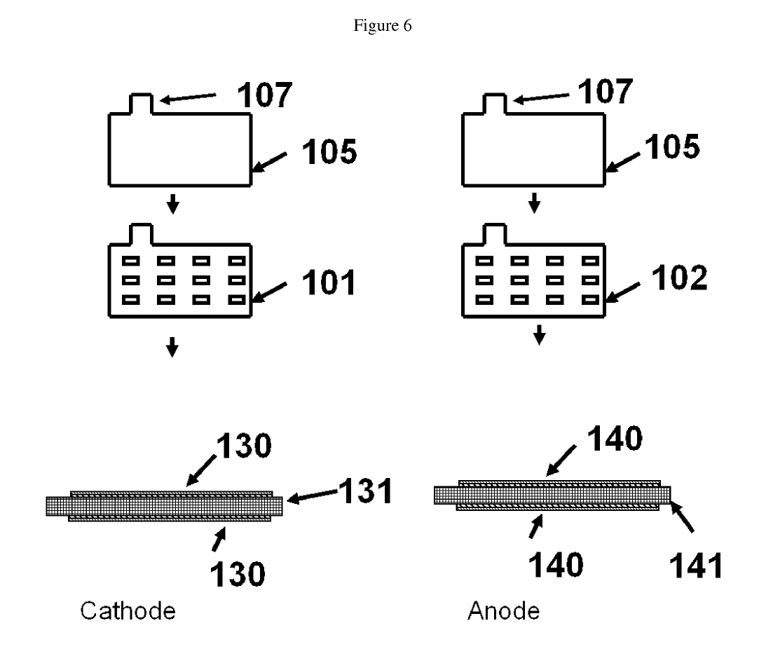

Using FIG. 6 as a reference, the material of the invention can be used to form a lead acid battery grid. First, two 0.005 inch thick piece of Melinex are cut into a 3 inch by 4 inch piece with a 1 inch by 0.5 inch tab on the top. This forms the blank for grid [105] and tab [107]. A grid pattern is cut out of each of the blanks. This forms grids preassembly [101] and [102].

A coating of the paste of PbO2 and CNT is applied [130] on both sides of the grid [101] to form the cathode [131]. The grid is cured for 20 min. at 90 degrees C. The anode is formed using the following method. A coating of Pb and CNT paste is applied [140] on both sides of the grid [102] forming the negative plate [141]. The grid is cured for 20 min. at 90 degrees C.

The detailed process is found below. The dispersions are formed by the following methods. The PbO2 is milled in a ball mill for 1 hour, and then the Pb is milled in a ball mill for 1 hour.

1. Next, 50 grams of PbO2 powder is suspended in 200 mls of nitric acid, and used to create defects on the surface of the PbO2 powder, thus generating nanotube connection sites as previously described. Here the PbO2 powder is sonicated with a Branson ultrasonic system until all the PbO2 is suspended in a dispersion. The PbO2 is then allowed to settle to the bottom of the container. The nitric acid is decanted so that only the PbO2 powder and enough nitric acid remains to cover the PbO2. The next step involves adding 200 mls of nitric acid to the PbO2 powder and then adding 2 grams of MWCNT, in this case also procured from Cheap Tubes of Brattleboro, Vt. The percentage of MWCNT's can be 0.1% to 10% of the PbO2 by weight. The mixture is then mixed for 20 minutes with a Branson ultrasonic system until all the material is dispersed in the container. Then the dispersion is poured into a filter paper cone and allowed to dry. The drying can be accelerated with heat or vacuum.

Once the material is suitably dried so that there is no more liquid nitric acid present in the material and the material is returned to a dry powder. Then the powder is added to 50 ml of acetone and mix to form a paste. As used herein a paste is a semi liquid form of a dispersion.

Next, 50 grams of Pb powder is suspended in 200 mls of nitric acid, and used to create defects on the surface of the Pb powder, thus generating nanotube connection sites as previously described. Here the Pb powder is sonicated with a Branson ultrasonic system until all the Pb is suspended in a dispersion. The Pb is then allowed to settle to the bottom of the container. The nitric acid is decanted so that only the Pb powder and enough nitric acid remains to cover the Pb. The next step involves adding 200 mls of nitric acid to the Pb powder and then adding 2 grams of MWCNT, in this case also procured from Cheap Tubes of Brattleboro, Vt. The percentage of MWCNT's can be 0.1% to 10% of the Pb by weight. The mixture is then mixed for 20 minutes with a Branson ultrasonic system until all the material is dispersed in the container. Then the dispersion is poured into a filter paper cone and allowed to dry. The drying can be accelerated with heat or vacuum.

Once the material is suitably dried so that there is no more liquid nitric acid present in the material and the material is returned to a dry powder. Then the powder is added to 50 ml of acetone and mix to form a paste. As used herein a paste is a semi liquid form of a dispersion.

Die cut two grid blanks [105] and [107] out of the Melinex, and then die cut the grid pattern to form grids [101] and [102]. Prior to application of the layers, clean both sides of the grids [101] and [102] with soap, rinse in pure water and allow drying. After the grids [101] and [102] have dried, perform a second cleaning step with methanol and lint free cloth and dry. First apply 10 ml PbO2 dispersion using a rod approximately 0.100 inches in diameter and of suitable length to spread the paste evenly to form, first coating [130] to both sides of grid [101]. Cure by drying for 20 min. at 95 degrees C.; the permissible variation is 10 min. to 25 min. and 75 degrees C. to 100 degrees C. This creates the positive plate [131].

Next, apply 10 ml Pb dispersion using a rod approximately 0.100 inches in diameter and of suitable length to spread the paste evenly to form coating [140] to both sides of grid [102]. Cure by drying for 20 min. at 95 degrees C.; the permissible variation is 10 min. to 25 min. and 75 degrees C. to 100 degrees C. This creates negative plate [141].

The battery is formed by making a cell using the anode and cathode suspended in a small beaker containing 35% H2SO4 and water solution with a 1.95 mm thick glass fiber separator, in this case made by Yangzhou Guo Tai Fiberglass Co., Ltd, between the two grids. The voltage, measured across the terminals, was 1.9 volts. The benefit to the structure is the elimination of the traditional lead grids.

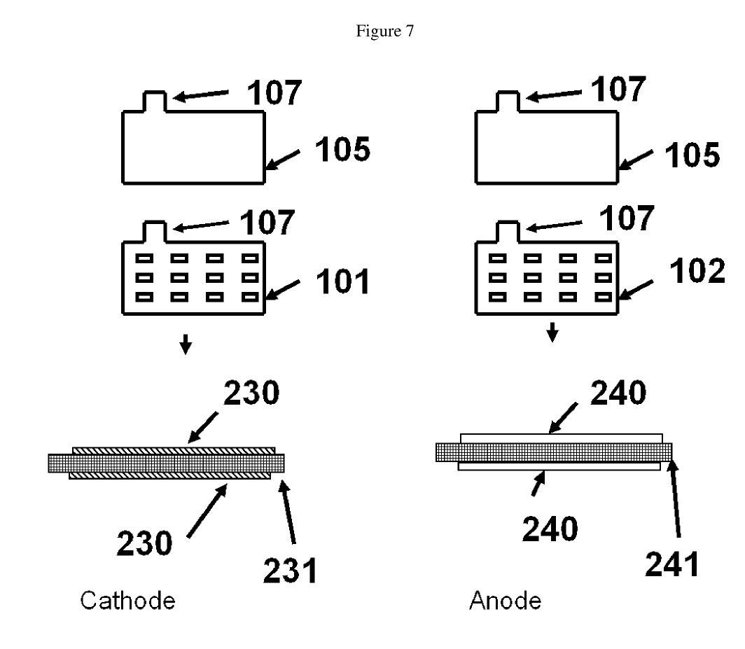

Using FIG. 7 as a reference, the material of the invention is used to form a silver zinc battery grid. First, two 0.005 inch thick pieces of Melinex are cut into a 3 inch by 4 inch piece with 1 inch by 0.5 inch tabs on the top. This forms the blank for grid [105] and tab [107]. Then a grid pattern is cut out of each of the blanks [105]. This forms grids preassembly [101] and [102].

Next, a coating of Silver oxide and CNT is coated [230] on both sides of the grid [101] to form the cathode [231] and cured for 20 minutes at 90 degrees C. The anode is formed by the following method. A coating of zinc and CNT is coated [240] on both sides of the grid [102] to form the anode [241] and cured for 20 minutes at 90 degrees C.

The detailed process is found below:

First, the zinc powder is milled in a ball mill for 1 hour.

Next, silver oxide powder is milled in a ball mill for 1 hour.

Next, 50 grams of zinc powder is suspended in 200 mls of nitric acid, and used to create defects on the surface of the zinc powder, thus generating nanotube connection sites as previously described. Here the zinc powder is sonicated with a Branson ultrasonic system until all the zinc is suspended in a dispersion. The zinc is then allowed to settle to the bottom of the container. The nitric acid is decanted so that only the zinc powder and enough nitric acid remains to cover the zinc. The next step involves adding 200 mls of nitric acid to the zinc powder and then adding 2 grams of MWCNT, in this case also procured from Cheap Tubes of Brattleboro, Vt. The percentage of MWCNT's can be 0.1% to 10% of the zinc by weight. The mixture is then mixed for 20 minutes with a Branson ultrasonic system until all the material is dispersed in the container. Then the dispersion is poured into a filter paper cone and allowed to dry. The drying can be accelerated with heat or vacuum.

Once the material is suitably dried so that there is no more liquid nitric acid present in the material and the material is returned to a dry powder. Then the powder is added to 50 ml of acetone and mix to form a paste. As used herein a paste is a semi liquid form of a dispersion.

Next, 50 grams of silver oxide powder is suspended in 200 mls of nitric acid, and used to create defects on the surface of the silver oxide powder, thus generating nanotube connection sites as previously described. Here the silver oxide powder is sonicated with a Branson ultrasonic system until all the silver oxide is suspended in a dispersion. The silver oxide is then allowed to settle to the bottom of the container. The nitric acid is decanted so that only the Pb powder and enough nitric acid remains to cover the silver oxide. The next step involves adding 200 mls of nitric acid to the silver oxide powder and then adding 2 grams of MWCNT, in this case also procured from Cheap Tubes of Brattleboro, Vt. The percentage of MWCNT's can be 0.1% to 10% of the silver oxide by weight. The mixture is then mixed for 20 minutes with a Branson ultrasonic system until all the material is dispersed in the container. Then the dispersion is poured into a filter paper cone and allowed to dry. The drying can be accelerated with heat or vacuum.

Once the material is suitably dried so that there is no more liquid nitric acid present in the material and the material is returned to a dry powder. Then the powder is added to 50 ml of acetone and mix to form a paste. Note that as used herein a “paste” is a semi liquid form of a dispersion.

Die cut two grid blanks [105] and [107] out of the Melinex and die cut the grid pattern to form grids [101] and [102]. Before applying the conductive layers, clean both sides of grids [101] and [102] with soap, rinse in pure water and allow drying. After the grids [101] and [102] have dried, perform a second cleaning step with methanol and a lint free cloth and dry. Then a rod approximately 0.100 inches in diameter and of suitable length can be used to coat the anode and cathode material with the dispersion.

Apply the active materials coating the grids [101] and [102] first, using a rod approximately 0.100 inches in diameter and of suitable length to apply 12 grams silver oxide paste and form coating [230] to both sides of grid [101]. Cure by drying for 20 min. at 95 degrees C.; the permissible variation is 10 min. to 25 min. and 75 degrees C. to 100 degrees C. This creates the cathode [231].

Next, using a rod approximately 0.100 inches in diameter and of suitable length to apply 10 grams of zinc and CNT paste to form coating [240] to both sides of grid [102]. Cure by drying for 20 min. at 95 degrees C.; the permissible variation is 10 min. to 25 min. and 75 degrees C. to 100 degrees C. This creates the anode [241].

The battery is formed by creating a cell using the anode and cathode suspended in a small beaker of potassium hydroxide (KOH) electrolyte and water solution with a 0.002 inch thick cellophane separator, in this case from Hollingsworth & Vose Company, between the two grids. The voltage measured across the terminals was 1.4 volts. The benefit of this structure is the elimination of the traditional silver and copper grids.

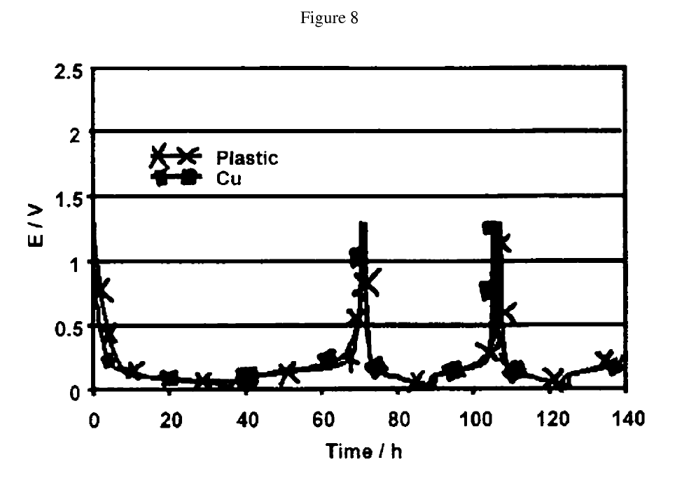

FIG. 8 is a graph showing a coating of the invention used as the current collector of a lithium-ion battery undergoing a charging and discharging sequence. A standard CR2430 size coin cell battery was formed using these current collectors. Liquid electrolyte consisting of solid lithium-salt LiPF6 and ether was added to form the battery. The system could also be formed with a gel polymer electrolyte.

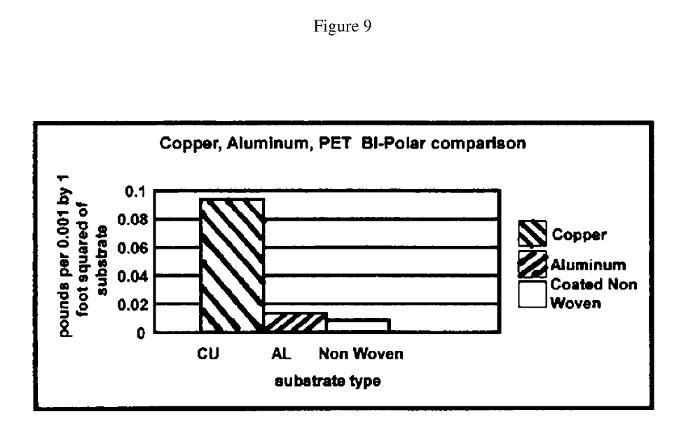

FIG. 9 is a graph of the weight of traditional materials versus the weight of materials of the invention. When compared with existing materials, the current collector materials made from conductive carbon nanotubes and binders are at least 25% lighter than traditional materials.

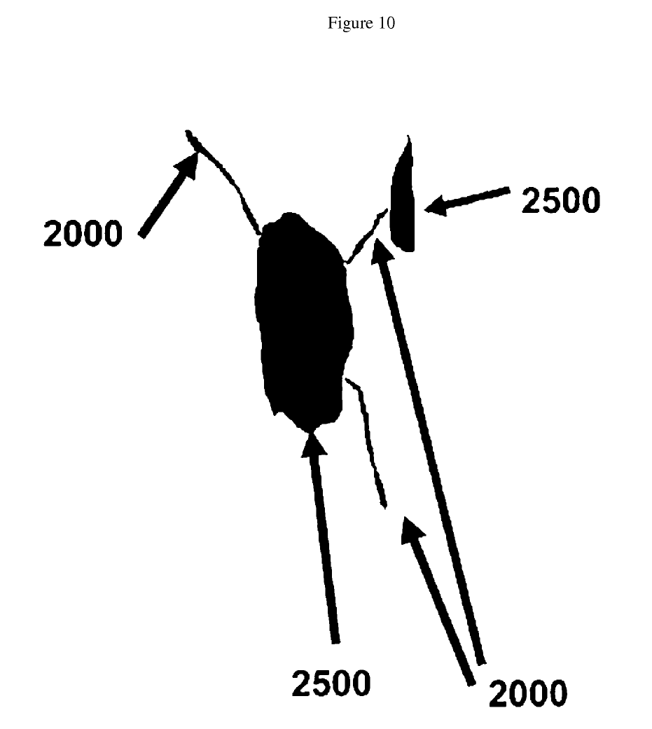

FIG. 10. is an SEM image of conductive film of the invention showing the bonds formed from carbon nanotube ropes [2000] between the larger conductive particles [2500] of copper powder used in the dispersion of the invention. A “carbon nanotube rope” is formed from two or more carbon nanotubes that knit together to form a string or rope structure, connecting two or more conductive particles or a mass of carbon nanotubes. The rope structure can also be multiple carbon nanotubes formed into a bundle and two or more bundles attached. The ropes provide a flexible and stabile connection between all the conductive and non-conductive materials; they interconnect the larger particles, creating a material with improved conductivity when compared to thick film materials applied in an average thickness less than 0.002 inches. This structure provides an easier fabrication process and more reproducible properties than materials of the prior art. The interconnection properties of the carbon nanotubes do not require that all the particles be in contact with each other and they create a flexible joint that allows the connection to both move and remain in electrical and thermal contact when the coating is stressed by heat, mechanical or chemical processes.

In another preferred embodiment, the coatings can be encapsulated with either a top coating. For li-ion current collectors the anode can either be plated with copper or be sputtered or vacuum deposited with aluminum to improve the handing of the current collector. When plating is used the anode is placed in a copper plating bath until the copper has coated the coated non-woven material. The spray coating has made the non-woven material conductive enough to permit the plating process. The Li-ion Cathode can be sputtered or vacuum deposited with aluminum.

### Further Discussion

As previously discussed, the curing process allows the carbon nanotubes to form bonds between themselves and other conductive materials in the dispersion after it is applied to a substrate. In batteries and other electrochemical applications, these coatings and infusions form conductive elements that can replace existing metal current collectors, grids and foils to transfer electrons to the cell or battery terminals, provide an excellent heat dissipation medium to the battery or cell wall where the heat is dissipated by transfer to the surrounding environment and do not interfere chemically with the electrochemical reaction.

These dispersions, as part of a conductive coating applied to a non-conductive surface and cured, allow the production of very repeatable, ductile, high bond strength coatings that are able to transfer heat, are chemically resistant to electrolytes and acids, and provide advantages for reduced cost. The carbon nanotube coating, on alloying other conductive materials and solvents, creates a boundary layer between the substrate and the other components of the coating such that the overall coating adheres better to the substrate, providing the carbon nanotubes with a pathway to increase the conduction of thermal and electrical energy between the other conductive materials in the coating. The coating also has the properties that allow it to infuse itself into the porous nature of the substrate. Dispersions of the invention are used to form conductive coatings with the required chemical and thermal stability that have good adhesion to the base substrate and provide excellent support for electrochemical processes.

The invention's dispersions and coatings are more capable of transferring heat and electrical current than existing printed ink technologies (which typically are dispersions of finely divided carbon, graphite, silver or silver chloride particles). Although the invention's nanotube—conductive particle alloys can be incorporated into materials such as thermoplastic resin and containing 20% to 60% solids if desired, in a preferred embodiment, no such thermoplastic binder will be used.

To recapitulate, the carbon nanotubes form strong conductive bonds with the conductive particles that are both flexible and bond the carbon nanotubes and other alloying materials together. In contrast to the finely divided particles of traditional coatings and inks, which tend to be at least 10 microns to 100 microns in diameter, and which create an inconsistent conductive path, the invention's coatings are superior. Specifically the carbon nanotube conductive coatings formed from the dispersions of the invention have the same conductive capacity and solid contents of about 0.0001% to 10% with carbon nanotube particle size less than 20 nm for the carbon nanotube portion of the dispersion. Compared to conventional inks and coatings, this is significantly smaller than the prior art 10 micron particle size range, and the solids content is 6 to 20 times less.

The creation of coatings with thermal and electrical conductivity, good adhesion and high chemical resistance are the result of dual action of the carbon nanotubes that form the interconnecting bonds between the larger conductive materials, as well as the physical properties of carbon nanotubes which make the transmission of both large quantities of heat and current possible. The high bond strength and the natural affinity of the carbon nanotubes to link or clump together to form ropes, combined with their thermal and electrical properties, make the coatings of the invention possible.

### Applications:

A critical metric of any battery cell is power density per unit of weight of the battery cell. This power density is dependent on the amount per gram of active ion in the coated active material, and how much active material that can adhere to a current collector. This forms a volumetric function which can be described as active material/cm³ (e.g. active battery material per unit volume). A key design feature of the invention is that the current collector substrate is porous, and the void space formed from the porous substrate can be filled with the battery cell active material. The active material loaded into the pore space has the beneficial result of increasing the amount of active material per unit volume on the anode or cathode which increases the power density of the battery cell.

### Utility for Welding and Soldering:

The various dispersions and coating discussed herein can also help facilitate both welding and soldering of the resulting coated structures. This is because the same structure that allows the solder to flow between the two parts being soldered also forms a natural ultrasonic energy concentrator. In the ultrasonic energy concentrator design, the mating surfaces make initial contact only along a raised portion of the work piece, ensuring that the ultrasonic energy is concentrated into a small area. As welding proceeds this material softens and flows to form the weld, allowing the rest of the contact surfaces to come together forming a natural stop.

Here, the invention facilitates the process because the nanotubes protruding from the surface of coatings of the invention naturally act as these ultrasonic energy concentrators. Additionally, this same structure is achievable so that the carbon nanotubes are protruding from the surface of the cured ink, dye, or coating formed from a wet dispersion. The dispersion ink, dye, or coating may incorporate carbon nanotubes into the wet dispersion forming in sufficient quantity so that they can form nano channels on the surface of the coating. The carbon nanotubes create the capillary that allows the liquid solder to flow or alternatively provide the initial attachment points/nano ultrasonic energy concentrator points for the ultrasonic welding after being applied and then cured with heat.

Although only a few exemplary embodiments of the present invention have been described in detail in this disclosure, those skilled in the art who review this disclosure will readily appreciate that many modifications are possible in the exemplary embodiments (such as variations in sizes, structures, shapes and proportions of the various elements, values of parameters or use of materials) without materially departing from the novel teachings and advantages of the invention.

Accordingly, all such modifications are intended to be included within the scope of the invention as defined in the appended claims.

Other substitutions, modifications, changes and omissions may be made in the design, operating conditions and arrangement of the preferred embodiments without departing from the scope of the invention as expressed in the appended claims.

Additional advantages, features and modifications will readily occur to those skilled in the art. Therefore, the invention in its broader aspects is not limited to the specific details and representative devices, shown and described herein. Accordingly, various modifications may be made without departing from the scope of the general inventive concept as defined by the appended claims and their equivalents.

All references cited herein, including all U.S. and foreign patents and patent applications, all priority documents, all publications, and all citations to government and other information sources, are specifically and entirely hereby incorporated herein by reference. It is intended that the specification and examples be considered exemplary only, with the true scope of the invention indicated by the following claims.

As used herein and in the following claims, articles such as “the”, “a” and “an” can connote the singular or plural.

1. A current collector device for use in a battery, said current collector comprising:
a substrate with at least one surface;
said at least one surface coated with a mixture of carbon nanotubes and secondary conducting particles;
wherein at least some carbon nanotubes form electrically conductive bridges between at least some of said secondary conducting particles.

2. The device of claim 1, wherein said substrate is a non electrically conductive substrate.

3. The device of claim 1, wherein said substrate comprises a non-woven fabric, fabric-like material, grid or veil, and wherein said at least one surface comprises both interior and exterior surfaces.

4. The device of claim 1, wherein said coating further comprises an organic polymer selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, poly(methlmethacrylate), polynucleotides and mixtures thereof, or ceramic hybrid polymers, ethylene glycol monobutyl ether acetate, phosphine oxides, chalcogenides, and other organic polymers.

5. The device of claim 1 where said secondary conducting particles comprise one or more particle types selected from the group consisting of carbon, Al, Cu Au—Ni, Au—Fe, Au—Co and Au—Ir, bi-metallics and their oxides, LiNiCoO2, LiNiCoAlO2, LiNiMnCoO2, coke, graphite, tin, mesocarbon microbeads (MCMB), silicon, non-metal oxides and metal oxides, Pb and PbO2, platinum, silver, zinc, silver oxide, zinc oxide, and other nanometals.

6. The device of claim 1, wherein said secondary conducting particles have an approximate diameter between about 0.5 nm to 100 microns, and wherein said secondary conducting particles have induced surface defects suitable for binding carbon nanotubes.

7. The device of claim 1, wherein said device is a battery cathode or battery anode.

8. The device of claim 1, wherein said secondary conducting particles comprise between 0.0001% to 60% of said coating by weight, and said carbon nanotubes comprise from 0.1% to 10% of said coating by weight.

9. The device of claim 1, wherein said device additionally comprises an electrically conductive metallic top coating that covers at least part of said at least one surface.

10. A current collector device for use in a battery, said current collector comprising:
a non-woven, non electrically conductive, fabric, fabric-like material, grid or veil substrate with an exterior surface and a porous internal matrix comprising interior surfaces;
said exterior and interior surfaces coated with a mixture of an organic polymer binder, carbon nanotubes and secondary conducting particles;
wherein said secondary conducting particles comprise one or more particle types selected from the group consisting of carbon, Al, Cu Au—Ni, Au—Fe, Au—Co and Au—Ir, bi-metallics and their oxides, LiNiCoO2, LiNiCoAlO2, LiNiMnCoO2, coke, graphite, tin, mesocarbon microbeads (MCMB), silicon, non-metal oxides and metal oxides, Pb and PbO2, platinum, silver, zinc, silver oxide, zinc oxide, and other nanometals;
wherein said secondary conducting particles have an approximate diameter between about 0.5 nm to 100 microns;
wherein said secondary conducting particles have induced surface defects suitable for binding carbon nanotubes;
wherein said secondary conducting particles comprise between 0.0001% to 60% of said coating by weight, and said carbon nanotubes comprise from 0.1% to 10% of said coating by weight;
wherein at least some carbon nanotubes form electrically conductive bridges between at least some of said secondary conducting particles.

11. A method of creating a current collector for a battery, said method comprising:
creating a dispersion, said dispersion comprising a mixture of carbon nanotubes, conductive secondary particles, and a curable binder;
applying said dispersion to a porous substrate with a substrate exterior surface and a substrate interior matrix surface such that said dispersion is absorbed onto both the substrate exterior surface and substrate interior matrix surface of said substrate, forming a substrate with coated dispersion;
curing said substrate with absorbed dispersion so that said curable binder binds said mixture of carbon nanotubes and conductive secondary particles to said substrate exterior surface and substrate interior matrix surface;
wherein in said cured substrate with absorbed dispersion, at least some of said nanotubes form conductive links between at least some of said conductive secondary particles.

12. The method of claim 11, wherein said substrate is a non-conductive substrate.

13. The method of claim 11, wherein said substrate is a non-woven fabric, fabric like material, grid or veil.

14. The method of claim 11, wherein said conductive secondary particles are treated to create defects or regions on the surface of said conductive secondary particles that are capable of binding to carbon nanotubes and creating electrically conductive links between said conductive secondary particles and said nanotubes.

15. The method of claim 14, wherein said treatment comprises an acid treatment.

16. The method of claim 11, where said conductive secondary particles comprise one or more particle types selected from the group consisting of carbon, Al, Cu Au—Ni, Au—Fe, Au—Co and Au—Ir, bi-metallics and their oxides, LiNiCoO2, LiNiCoAlO2, LiNiMnCoO2, coke, graphite, tin, mesocarbon microbeads (MCMB), silicon, non-metal oxides and metal oxides, Pb and PbO2, platinum, silver, zinc, silver oxide, zinc oxide, and other nanometals.

17. The method of claim 16, wherein said conductive secondary particles have an approximate diameter between about 0.5 nm to 100 microns.

18. The method of claim 11, wherein said conductive secondary particles comprise between 0.0001% to 60% of said dispersion by weight, said carbon nanotubes comprise from 0.1% to 10% of said dispersion by weight, and the substantial remainder of said dispersion comprises an organic polymer binder and a solvent for said binder.

19. The method of claim 11, further partially encapsulating said cured substrate with a conductive metallic top coating by an electrical plating, spray coating, or vacuum deposition process.

20. The method of claim 11, wherein said carbon nanotubes at attached to the said defects of said secondary conducting particles defects to form a powder of carbon nanotubes and secondary conducting particles prior to forming a dispersion for coating of secondary conducting particles and carbon nanotubes.
